(19) United States
(12) Patent Application Publication
(10) Pub. No.: US 2026/0129730 A1
(43) Pub. Date: May 7, 2026

(54) LED CIRCUITS AND ASSEMBLIES

(71) Applicant: Lynk Labs, Inc., Elgin, IL (US)

(72) Inventors: Michael Miskin, Sleepy Hollow, IL (US); Robert L. Kottritsch, Shefford Bedfordshire (GB)

(21) Appl. No.: 19/391,529

(22) Filed: Nov. 17, 2025

Related U.S. Application Data
(63) Continuation of application No. 18/233,724, filed on Aug. 14, 2023, now Pat. No. 12,477,634.
Application No. 18/233,724 is a continuation of application No. 17/728,516, filed on Apr. 25, 2022, now Pat. No. 11,729,884.
Application No. 17/728,516 is a continuation of application No. 17/233,891, filed on Apr. 19, 2021, now Pat. No. 11,317,495.
Application No. 17/233,891 is a continuation of application No. 15/334,001, filed on Oct. 25, 2016, now Pat. No. 10,986,714.
Application No. 15/334,001 is a continuation-in-part of application No. 14/172,644, filed on Feb. 4, 2014, now Pat. No. 9,750,098.
Application No. 14/172,644 is a continuation of application No. 13/322,796, now Pat. No. 8,648,539.
Application No. 13/322,796 is a continuation-in-part of application No. 12/287,267, filed on Oct. 6, 2008, now Pat. No. 8,179,055.
(60) Provisional application No. 60/997,771, filed on Oct. 6, 2007.
(60) Provisional application No. 61/217,215, filed on May 28, 2009.

(51) Int. Cl. H05B 45/42; H05B 45/37; H05B 45/40

(52) U.S. Cl. CPC H05B 45/42; H05B 45/37; H05B 45/40; Y10T 29/49002

(57) ABSTRACT

An LED lighting device is disclosed. The LED lighting device includes a first LED circuit and at least one additional LED circuit. The first LED circuit and the at least one additional LED circuit each include LEDs connected in series. The LEDs in the first LED circuit emit a different color of light than the LEDs in the at least one additional LED circuit. The LED lighting device also includes a switch configured to be actuated by an end user and provide the end user with a means to produce a change in brightness of at least one of the first LED circuit or the at least one additional LED circuit.

### PRIORITY CLAIM

This application is a continuation of U.S. patent application Ser. No. 18/233,724, filed Aug. 14, 2023, which is a continuation of U.S. patent application Ser. No. 17/728,516, filed Apr. 25, 2022, now U.S. Pat. No. 11,729,884, which is a continuation of U.S. patent application Ser. No. 17/233,891, filed Apr. 19, 2021, now U.S. Pat. No. 11,317,495, which is a continuation of U.S. patent application Ser. No. 15/334,001, filed Oct. 25, 2016, now U.S. Pat. No. 10,986,714, which is a continuation-in-part of U.S. patent application Ser. No. 14/172,644, filed Feb. 4, 2014, now U.S. Pat. No. 9,750,098, which is a continuation of U.S. patent application Ser. No. 13/322,796, filed Nov. 28, 2011, now U.S. Pat. No. 8,648,539, which is a national phase application of International Application No. PCT/US2010/001597, filed May 28, 2010, which claims priority to U.S. Provisional Application No. 61/217,215, filed May 28, 2009, and is a continuation-in-part of U.S. patent application Ser. No. 12/287,267, filed Oct. 6, 2008, now U.S. Pat. No. 8,179,055, which claims the priority to U.S. Provisional Application No. 60/997,771, filed Oct. 6, 2007; the contents of each of these applications are expressly incorporated herein by reference.

### TECHNICAL FIELD

The present invention relates generally to light-emitting diode (“LED”) circuits and assemblies; and more specifically to scalable alternating current (“AC”) driven LED circuits and assemblies.

### SUMMARY

While not intending to limit the scope of the claims or disclosure, in brief summary, the present disclosure and claims are directed to providing improved ease of designing and building lighting fixtures using AC-driven LEDs. Disclosed and claimed are LED circuits having scalable circuit configurations and LED package assembly configurations which can be used in an AC-drive platform to more easily match the voltage requirements of the lighting fixture(s) or systems in which the LED's are desired. Circuits and LED package assemblies are claimed and disclosed which reduce objectionable flicker produced from AC-driven LEDs and to produce more light per component. Packaged LED's are provided for lighting design according to the invention, which address flicker at low frequencies (e.g. 50/60 Hz) while being scalable as desired for a particular lighting goal without resort to designing individual assemblies at the semiconductor die level. Circuits are also disclosed and claimed which provide for some of the LEDs in a circuit to be on during both positive and negative phases of an AC source, to among other things, address flicker. Also, circuits are claimed and disclosed where a basic circuit design provides a voltage and current performance whereby scalability or matching a particular voltage requirement is achieved by configuring LEDs in the basic design and/or by joining one or more of the basic circuits together in series or parallel to achieve the design requirement.

According to an embodiment of the invention, an AC-driven LED circuit is proposed having a first parallel circuit having LEDs. Each LED has an input and an output, and the circuit having at least first and second branches connecting at first and second common points, the common points providing input and output for an AC driving current for the circuit. The first branch having a first and a second LED, and the second branch having a third and a fourth LED. The first LED is connected to the second LED in opposing series relationship with the inputs of the first and second LEDs defining a first branch junction. The third LED is connected to the fourth LED in opposing series with the outputs of the third and fourth LEDs defining a second branch junction. The first and second branches are connected to one another such that the output of the first LED is connected to the input of the third LED at the first common point and the output of the second LED is connected to the input of the fourth LED at the second common point. A first cross-connecting circuit branch having at least a fifth LED, the first cross-connecting circuit being configured such that the input of the fifth LED is connected to second branch junction and the output is connected to the first branch junction.

According to another embodiment of the invention, an AC-driven LED circuit may comprise one or more additional parallel circuits each being the same as the first parallel circuit identified above. Each additional circuit being conductively connected to the first parallel circuit and to one another at their common points for providing an input and an output for an AC driving current of the circuit. According to other embodiments, the additional parallel circuits may be connected in series to the first parallel circuit and to one another or the additional parallel circuits may be connected in parallel to the first parallel circuit and to one another.

According to another embodiment of the invention, n additional LEDs, in pairs, may be provided in the circuit wherein the pairs are configured among the first and second branch circuits of each of the respective parallel circuits, such that current flows through the respective fifth diode of each parallel circuit upon both a negative and positive phase of the AC driving source and so that the current draw through each of the respective parallel circuits during both AC phases is substantially the same.

According to another embodiment, the AC-driven LED circuit further comprises x cross-connecting circuit branches each having one or more LEDs and being configured such that current flows through each of the respective one or more LEDS upon both a negative and positive phase of the AC driving source and so that the current draw through each of the respective parallel circuits during both AC phases is substantially the same.

According to another embodiment of the invention, an AC-driven LED assembly comprises at least a first and a second LED each discretely packaged, the LEDs being connected in an AC circuit and each LED package being mounted to a substrate at a distance from the other of preferably approximately 3 mm or less, and more preferably 2.0 mm or less. In an embodiment the packaged LEDs also each have a length of preferably approximately 2.5 mm or less, and more preferably 2.0 mm or less. In an embodiment the packaged LEDs also each have a width of preferably approximately 2.5 mm or less, and more preferably 2.0 mm or less. In an embodiment the LED packages are arranged with respect to each other in a linear spatial relationship while in another embodiment the LED packages are arranged with respect to each other in an XY rectilinear spatial relationship. In an embodiment of the invention, one or more LED packages may include a reflective material.

### BRIEF DESCRIPTION OF THE DRAWINGS

FIG. 1 is a schematic view of an AC-driven LED circuit, according to an embodiment of the invention;

FIG. 2 is a schematic view of an AC-driven LED circuit, according to an embodiment of the invention;

FIG. 3 is a schematic view of an AC-driven LED circuit, according to an embodiment of the invention;

FIG. 4 is a schematic view of an AC-driven LED circuit, according to an embodiment of the invention;

FIG. 5 is a schematic view of an AC-driven LED circuit, according to an embodiment of the invention;

FIG. 6 is a schematic top view of an AC-driven LED assembly, according to an embodiment of the invention;

FIG. 7 is a schematic top view of an AC-driven LED assembly, according to an embodiment of the invention;

FIG. 8 is a schematic side view of an AC-driven LED assembly, according to an embodiment of the invention;

FIG. 9 is a schematic view of an AC-driven LED circuit, according to an embodiment of the invention;

FIG. 10 is a schematic view of an AC-driven LED circuit, according to an embodiment of the invention;

FIG. 11 is a schematic view of a multi-voltage and/or multi-brightness LED lighting device according to an embodiment of the invention;

FIG. 12 is a schematic view of a multi-voltage and/or multi-brightness LED lighting device integrated within a lamp according to an embodiment of the invention; and

FIG. 13 is a schematic view of a multi-voltage and/or multi-brightness LED lighting device with a switch connected to an AC voltage source, according to an embodiment of the invention.

### DETAILED DESCRIPTION

While this invention is susceptible to embodiments in many different forms, there are shown in the drawings and will herein be described in detail, preferred embodiments of the invention with the understanding that the present disclosures are to be considered as exemplifications of the principles of the invention and are not intended to limit the broad aspects of the invention to the embodiments illustrated. Like components in the various FIGS. will be given like reference numbers.

FIG. 1 discloses an AC-driven LED circuit 10 including a first parallel circuit 12 having a first branch 14, and a second branch 16. Branches 14, 16 connect at first common point 18 and second common point 20. The common points 18, 20 provide input and output for an AC driving current from a driver 24 for the circuit. The driver may be, for example, mains power, an electronic transformer, or a magnetic transformer.

The first branch 14 has a first LED 26 and a second LED 28, and the second branch 16 having a third LED 30 and a fourth LED 32. The first LED 26 is connected to the second LED 28 in opposing series relationship with the inputs of the first and second LEDs 26, 28 defining a first branch junction 34. The third LED 30 is connected to the fourth LED 32 in opposing series with the outputs of the third and fourth LEDs 30, 32 defining a second branch junction 36.

The first and second branches 14, 16 are connected to one another such that the output of the first LED 26 is connected to the input of the third LED 30 at the first common point 18 and the output of the second LED 28 is connected to the input of the fourth LED 32 at the second common point 20. A first cross-connecting circuit branch 38 has a fifth LED 40. The first cross-connecting circuit branch 38 being configured such that the input of the fifth LED 40 is connected to second branch junction 36 and the output is connected to the first branch junction 34.

As will be appreciated by those of skill in the art, the LEDs 26 and 32 provide light only upon one half of an AC wave, pulse or phase, while the LEDs 28 and 30 will provide light only upon the opposite wave, pulse or phase. At lower frequencies, e.g. mains frequencies, if the LEDs are spaced pursuant to another aspect of the invention (disclosed below) at preferably approximately 3.0 mm or less preferably approximately 2.0 mm or less, then the amount of noticeable flicker may not be unacceptable. However, the cross connecting circuit 38 and diode 40 will be on (produce light) in both phases of the AC drive and hence mitigate flicker which may be evidenced in its surrounding LEDs 26, 28, 30 and 32.

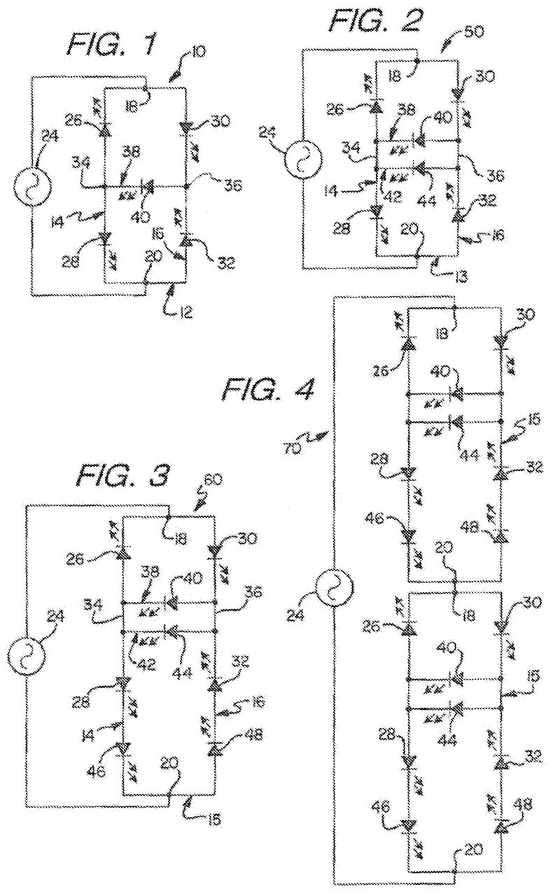

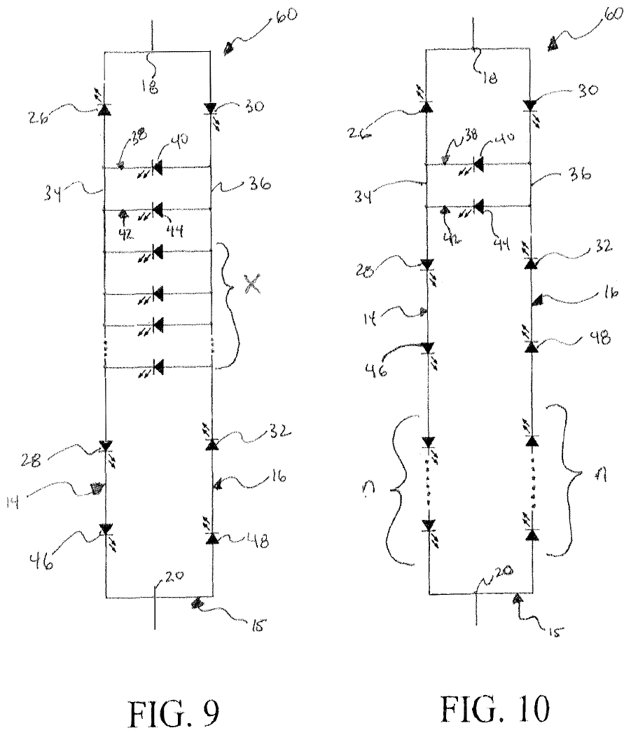

FIG. 2 discloses an AC-driven LED circuit 50 which is a modification of AC-driven LED circuit 10. Circuit 50 further mitigates flicker. Circuit 50 provides an additional cross-connecting circuit branch 42 having LED 44. The LEDS 40, 44 are configured such that current flows through each upon both a negative and positive phase of the AC driving source 24. It should be appreciated that according to the invention x number of such cross connecting circuit branches (such as 38, 42) may be added as desired (see for example FIG. 9), however, since the LEDs (such as LEDs 40, 44) are in parallel with each other, their voltage demand will be divided while their current draw will not. Hence a suitable driver need be provided for this circumstance.

To increase the light output of the circuit of the invention, it should be noted as disclosed in FIGS. 3 and 10 that additional or n LEDS may be provided in the branches 14 and 16. Specifically FIG. 3 discloses an AC-driven circuit 60 which is a modification of circuit 50. Circuit 60 provides for additional LEDs 46 and 48. The pair of LEDs are configured among the first and second branch circuits 14, 16 of the parallel circuit 15 such that current flows through the respective diodes 40, 44 upon both a negative and positive phase of the AC driving source 24 and so that the current draw through parallel circuit 15 during both AC phases is substantially the same.

It should be noted that according to the invention, n pairs of LEDs can be configured among first and second branch circuits of a respective parallel circuit (see for e.g., FIG. 10), such that current flows through the respective cross connecting circuit branch LEDs of a parallel circuit upon both a negative and positive phase of the AC driving source and so that the current draw through each of the respective parallel circuits during both AC phases is substantially the same. More LEDs in the branch circuits divide the current from the higher current LEDs in cross connecting circuits 38, 42.

According to another aspect of the invention, to further mitigate the amount of flicker perceived, adding to the light provided and to scalability, additional parallel circuits, each being the same as the first parallel circuit, may be conductively connected to the first parallel circuit in series or parallel at the their common points 18, 20 for providing an input and an output for an AC driving current for the circuit.

For instance, FIG. 4 discloses an AC-driven LED circuit 70 which includes additional parallel circuits 15 connected in series at common points 18, 20. Additionally, as seen in FIG. 5, an AC-driven LED circuit 80 includes additional parallel circuits 15 connected in parallel at common points 18, 20. This embodiment shows the utility of providing a scalable circuit that can be manufactured modularly and used to connect to match higher voltage requirements e.g. circuit 15 may draw drawing 12 V AC while two such circuits 15 in series would meet 24 V AC requirements.

Preferably, the number and type of LEDs in the AC-driven LED circuit draws a combined current and combined voltage which is substantially equal to the nominal voltage capacity of the AC drive source.

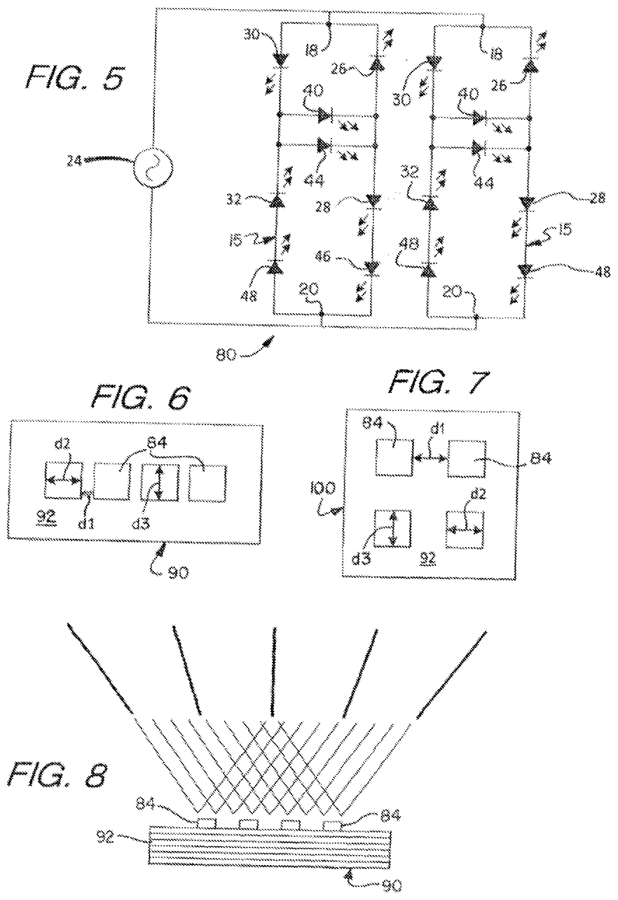

As shown in FIG. 6, an AC-driven LED assembly 90 has a first and a second LED 82 each discretely packaged, the LEDs being connected in an AC circuit and each LED package 82 being mounted to a substrate 92 at a distance dl from the other of preferably approximately 3 mm or less, and more preferably 2.0 mm or less. The first and second LEDs may be, for example, discrete packaged semiconductor LED die or LED chips. The AC-driven LED assembly 90 also has packaged LEDs 84 each having a width d2 and a length d3 of preferably approximately 2.5 mm or less, and more preferably 2.0 mm or less.

FIG. 6 discloses an AC-driven LED assembly 90 wherein the LED packages 84 are arranged with respect to each other in a linear spatial relationship, while FIG. 7 discloses an assembly 100 wherein the LED packages 84 are arranged with respect to each other in an XY rectilinear spatial relationship.

As can be seen in FIG. 8, when LED packages 84 are placed at 3 mm or less, the light produced there from intersects, thereby reducing or eliminating the effects of flicker.

Some standard AC voltages in the world include 12VAC, 24VAC, 100VAC, 110VAC, 120VAC, 220VAC, 230VAC, 240VAC and 277VAC. Therefore, it would be advantageous to have a single chip LED or multi-chip single LED packages that could be easily configured to operate at multiple voltages by simply selecting a voltage and/or current level when packaging the multi-voltage and/or multi-current single chip LEDs or by selecting a specific voltage and/or current level when integrating the LED package onto a printed circuit board or within a finished lighting product. It would also be advantageous to have multi-current LED chips and/or packages for LED lamp applications in order to provide a means of increasing brightness in LED lamps by switching in additional circuits just as additional filaments are switched in for standard incandescent lamps.

It would further be advantageous to provide multiple voltage level and/or multiple brightness level light emitting LED circuits, chips, packages and lamps “multi-voltage and/or multi-brightness LED devices” that can easily be electrically configured for at least two forward voltage drive levels with direct AC voltage coupling, bridge rectified AC voltage coupling or constant voltage DC power source coupling. This invention comprises circuits and devices that can be driven with more than one AC or DC forward voltage “multi-voltage” at 6V or greater based on a selectable desired operating voltage level that is achieved by electrically connecting the LED circuits in a series or parallel circuit configuration and/or more than one level of brightness “multibrightness” based on a switching means that connects and/or disconnects at least one additional LED circuit to and/or from a first LED circuit. The desired operating voltage level and/or the desired brightness level electrical connection may be achieved and/or completed at the LED packaging level when the multivoltage and/or multi-brightness, circuits and/or single chips are integrated into the LED package, or the LED package may have external electrical contacts that match the integrated multi-voltage and/or multi-brightness circuits and/or single chips within, thus allowing the drive voltage level and/or the brightness level select-ability to be passed on through to the exterior of the LED package and allowing the voltage level or brightness level to be selected at the LED package user, or the PCB assembly facility, or the end product manufacturer.

It would further be advantageous to provide multi-brightness LED devices that can be switched to different levels of brightness by simply switching additional circuits on or off in addition to a first operating circuit within a single chip and or LED package. This would allow LED lamps to switch to higher brightness levels just like 2-way or 3-way incandescent lamps do today.

According to another aspect of the invention a multi-voltage and/or multi-current single chip AC LED and/or multi-voltage and/or multi-current AC LED package is integrated within an LED lamp. The LED lamp having a structure that comprises a heat sink, a lens cover and a standard lamp electrical base. The multi-voltage and/or multi-current single chip AC LED and/or package is configured to provide a means of switching on at least one additional single voltage AC LED circuit within multi-voltage and/or multicurrent AC LED circuit to provide increased brightness from the LED lamp.

According to another aspect of the invention, at least one single chip multi-current LED bridge circuit is integrated within a LED lamp having a standard lamp base. The single chip multi-current LED bridge circuit may be electrically connected together in parallel configuration but left open to accommodate switching on a switch to the more than one on the single chip and have at least one accessible electrical contact at each opposing end of the two series connected circuits and one accessible electrical contact at the center junction of the at least two individual serially connected LED circuits. The at least two individual circuits are integrated within a single chip.

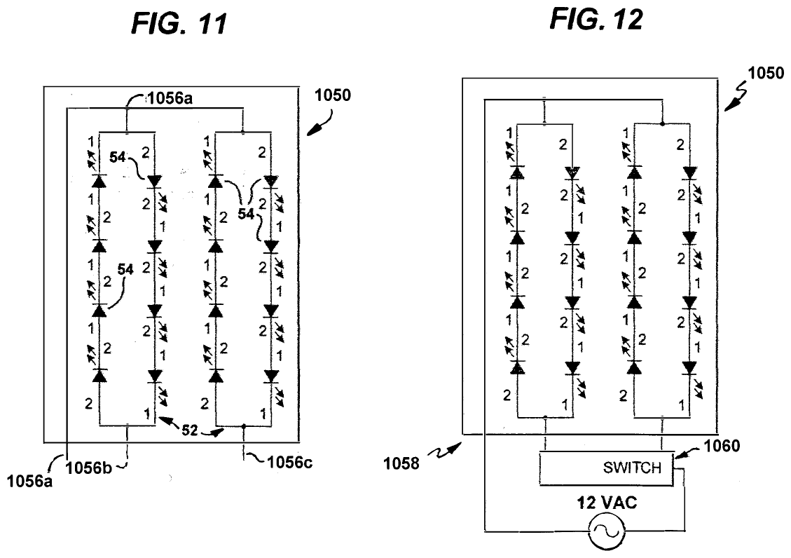

FIG. 11 discloses a schematic diagram of a multi-voltage and/or multi-brightness LED lighting device 1050. The multi-voltage and/or multi-brightness LED lighting device 1050 comprises at least two AC LED circuits 1052, each of which have at least two LEDs 1054 in series and anti-parallel relation. The at leak two AC LED circuits 1052 have at least three electrical contacts 1056 a, 1056 b and 1056 c. The at least two AC LED circuits 1052 are electrically connected together in parallel at one end 1056 a and left unconnected at the opposing ends of the electrical contacts 1056 b and 1056 c. One side of an AC voltage source line is electrically connected to 1056 a and the other side of an AC voltage source line is individually electrically connected to 1056 b and 1056 c with either a fixed connection or a switched connection thereby providing a first brightness when AC voltage is applied to 1056 a and 1056 b and a second brightness when an AC voltage is applied to 1056 a, 1056 b and 1056 c. It is contemplated that the multi-voltage and/or multi-brightness LED lighting device 1050 is a single chip, an LED package, an LED assembly or an LED lamp. The multi-brightness switching capability.

FIG. 12 discloses a schematic diagram similar to the multi-voltage and/or multi-brightness LED device 1050 shown in FIG. 11 integrated within a lamp 1058 and connected to a switch 1060 to control the brightness level of the multi-voltage and/or multi-brightness LED lighting device 1050.

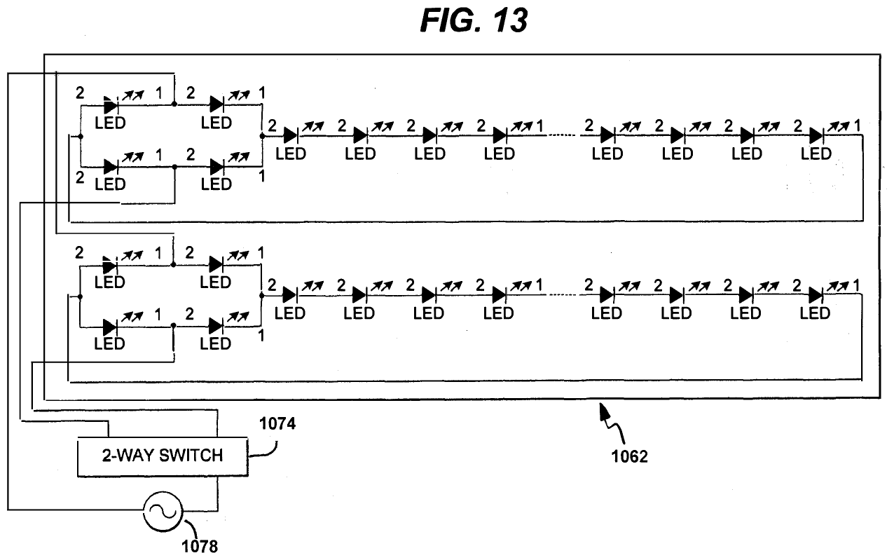

FIG. 13 discloses a schematic diagram the multi-brightness LED lighting device 1062 with a switch 1074 electrically connected between the multi-brightness LED lighting device 1062 and the AC voltage source 1078.

FIG. 13 discloses a schematic diagram of at least two single voltage LED circuits integrated with a single chip or within a substrate and forming a multi-voltage and/or multi-brightness LED device.

A package in certain applications may preferably also include a heat sink, a reflective material, a lens for directing light, phosphor, nano-chrystals or other light changing or enhancing substances. In some embodiments, an LED circuit includes at least two LEDs. At least one of the at least two LEDs includes a different phosphor coating than that of at least one other LED of the at least two LEDs. In sum, according to one aspect of the invention, the LED circuits and AC drivers of the present invention permit pre-packaging of the LED portion of a lighting system to be used with standardized drivers of known specified voltage and frequency output. Such packages can be of varied make up and can be combined with each other to create desired systems given the scalable and compatible arrangements possible with, and resulting from, the invention.

According to an aspect of the invention, an LED circuit driver provides a relatively fixed voltage and relatively fixed frequency AC output such as mains power sources. The LED circuit driver output voltage and frequency delivered to the LED circuit may be higher or lower than mains power voltage and frequencies by using an LED circuit inverter driver.

The higher frequency LED circuit Inverter driver may be an electronic transformer, halogen or high intensity discharge (HID) lamp type driver with design modifications for providing a relatively fixed voltage as the LED circuit load changes. Meaning if the LED circuit inverter driver is designed to have an output voltage of 12V LED circuit driver would provide this output as a relatively constant output to a load having one or more than one LED circuits up to the wattage limit of the LED circuit driver even if LED circuits were added to or removed from the output of the LED circuit driver.

As would be known to one skilled in the art, various embodiments of the LED packages, substrates, and assemblies may be produced, such as creating an AC-driven circuit where all circuits and LEDs are formed on a semiconductor, where the LED are discretely packaged apart from the circuits, and where each parallel circuit is formed on a printed circuit board.

While in the preceding there has been set forth a preferred embodiment of the invention, it is to be understood that the present invention may be embodied in other specific forms without departing from the spirit or central characteristics thereof. The present embodiments, therefore, are to be considered in all respects as illustrative and not restrictive, and the invention is not to be limited to the details given herein. While specific embodiments have been illustrated and described, numerous modifications come to mind without significantly departing from the characteristics of the invention and the scope of protection is only limited by the scope of the accompanying Claims.

The invention is claimed as follows:

1. An LED lighting device comprising:
a first LED circuit and at least one additional LED circuit,
wherein the first LED circuit and the at least one additional LED circuit each includes packaged LEDs connected in series,
wherein the packaged LEDs in the first LED circuit emit a different color of light than the packaged LEDs in the at least one additional LED circuit, and
wherein at least two of the packaged LEDs in the first LED circuit are separated from each other by a distance of 3 mm or less; and
a switch configured to be actuated between different positions by an end user and provide the end user with a first position for selecting at least one of a different level of voltage or current to be input to at least one of the first LED circuit and the at least one additional LED circuit to produce a change in brightness of the at least one of the first LED circuit and the at least one additional LED circuit,
wherein the switch is integrated within the LED lighting device such that the switch is positioned to enable actuation by the end user.

2. The LED lighting device of claim 1, further comprising a lighting device package, wherein the lighting device package includes wire leads for electrical connection of the LED lighting device to a mains power source.

3. The LED lighting device of claim 1, further comprising at least one LED driver circuit configured to receive a high voltage input from a mains power source and provide a lower voltage DC output to at least one of the first LED circuit or the at least one additional LED circuit.

4. The LED lighting device of claim 1, wherein the first LED circuit and the at least one additional LED circuit are driven with a different DC voltage level based on a position of the switch.

5. The LED lighting device of claim 1, further comprising a driver configured to provide a voltage and a current to only one of the first LED circuit or the at least one additional LED circuit when the end user actuates the switch.

6. The LED lighting device of claim 1, further comprising a PCB substrate, wherein at least one packaged LED from the first LED circuit and at least one packaged LED from the at least one additional LED circuit are mounted on the PCB substrate and separated from each other by a distance of 3 millimeters (“mm”) or less.

7. The LED lighting device of claim 1, further comprising at least one LED driver circuit configured to receive a voltage input from a mains power source and provide a DC voltage output of at least 24 volts to at least one of the first LED circuit and the at least one additional LED circuit when at least one of the first LED circuit or at least one additional LED circuit is emitting light.

8. The LED lighting device of claim 1, wherein the switch is mounted on a printed circuit board with the first LED circuit and the at least one additional LED circuit.

9. An LED lighting device comprising:
a first LED circuit and at least one additional LED circuit,
wherein the first LED circuit and the at least one additional LED circuit each includes packaged LEDs,
wherein the packaged LEDs in the first LED circuit emit a different color of light than the packaged LEDs in the at least one additional LED circuit, and
wherein the packaged LEDs in the first LED circuit and the packaged LEDs in the at least one additional LED circuit are separated from each other by a distance of 3 mm or less; and
a switch configured to be actuated between different positions by an end user and provide the end user with a first position for selecting at least one of a different level of voltage or current to be input to at least one of the first LED circuit and the at least one additional LED circuit to produce a change in brightness of the at least one of the first LED circuit and the at least one additional LED circuit,
wherein the switch is positioned to enable actuation by the end user.

10. The LED lighting device of claim 9, further comprising a lighting device package that includes wire leads for electrical connection of the LED lighting device to a mains power source.

11. The LED lighting device of claim 9, further comprising at least one LED driver circuit configured to receive a high voltage input from a mains power source and provide a lower voltage DC output of at least 24 volts to at least one of the first LED circuit or the at least one additional LED circuit when at least one of the first LED circuit or at least one additional LED circuit is emitting light.

12. The LED lighting device of claim 9, further comprising a driver configured to provide a voltage and a current to only one of the first LED circuit or the at least one additional LED circuit when the end user actuates the switch.

13. The LED lighting device of claim 9, further comprising at least one LED driver circuit configured to receive a high voltage input from a mains power source and provide a DC voltage output to at least one of the first LED circuit and the at least one additional LED circuit.

14. The LED lighting device of claim 9, wherein the first LED circuit and the at least one additional LED circuit are driven with a different DC voltage level based on a position of the switch.

15. The LED lighting device of claim 9, further comprising a PCB substrate, wherein at least one packaged LED from the first LED circuit and at least one packaged LED from the at least one additional LED circuit are mounted on the PCB substrate and separated from each other by a distance of 3 millimeters (“mm”) or less.

16. The LED lighting device of claim 9, wherein the switch is mounted on a printed circuit board with the first LED circuit and the at least one additional LED circuit.

17. An LED lighting device comprising:
a first LED circuit and at least one additional LED circuit,
wherein the first LED circuit and the at least one additional LED circuit each includes packaged LEDs mounted on a single substrate,
wherein the packaged LEDs in the first LED circuit emit a different color of light than the packaged LEDs in the at least one additional LED circuit, and
wherein the packaged LEDs in the first LED circuit and the packaged LEDs in the at least one additional LED circuit are separated from each other by a distance of 3 mm or less; and
a switch configured to be actuated between different positions by an end user and provide the end user with a first position for selecting at least one of a different level of voltage or current to be input to at least one of the first LED circuit and the at least one additional LED circuit to produce a change in brightness of at least one of the first LED circuit or the at least one additional LED circuit,
wherein the switch is integrated within the LED lighting device such that the switch is positioned to enable actuation by the end user.

18. The LED lighting device of claim 17, further comprising a lighting device package, wherein the lighting device package includes wire leads for electrical connection of the LED lighting device to a mains power source.

19. The LED lighting device of claim 17, further comprising at least one LED driver circuit configured to receive a high voltage input from a mains power source and provide a lower voltage DC output to at least one of the first LED circuit or the at least one additional LED circuit.

20. The LED lighting device of claim 17, wherein the first LED circuit and the at least one additional LED circuit are driven with a different DC voltage level based on a position of the switch.
